(19) United States
(12) Patent Application Publication
(10) Pub. No.: US 2006/0112743 A1
(43) Pub. Date: Jun. 1, 2006

(54) Alignment structure for combining a lever handle with a handle lock mechanism

(75) Inventor: Mei-Kuei Lee, Kaohsiung Hsien (TW)

Correspondence Address: NIKOLAI & MERSEREAU, P.A., 900 SECOND AVENUE SOUTH, SUITE 820, MINNEAPOLIS, MN, 55402, US

(73) Assignee: Taiwan Fu Hsing Industrial Co., Ltd., Kaohsiung Hsien (TW)

(21) Appl. No.: 11/001,515

(22) Filed: Dec. 1, 2004

(51) Int. Cl. E05B 13/10

(52) U.S. Cl. 70/224

(57) ABSTRACT

An alignment structure includes a handle lock mechanism, a lever handle and a spindle barrel. An end of the handle lock mechanism bears a spindle rod member to combine with the spindle barrel. The lever handle provides with an assembling through-hole and a retaining wall thereof. Received in the spindle barrel is the spindle rod member of the handle lock mechanism and the spindle barrel further provides with a positioning protrusion. In assembling operation, a recessed groove of the assembling through-hole engages with the positioning protrusion of the spindle barrel and the retaining wall of the lever handle abuts against the positioning protrusion of the spindle barrel. An end of the spindle barrel is exposed in an annular edge of the assembling through-hole and horizontally aligned with a side surface of the lever handle.

### BACKGROUND OF THE INVENTION

1. Field of the Invention

The present invention relates to an alignment structure for combing a lever handle with a handle lock mechanism. More particularly, the present invention relates to a lever handle and a spindle barrel of a handle lock mechanism provided with a retaining wall and a positioning protrusion that permits precisely assembling the handle lock mechanism with ease.

2. Description of the Related Art

Many patents describe methods for correct aligning and assembling the handle lock mechanism. Conventionally, a number of design limitations exist for assembling the lever handle and the spindle of the handle lock mechanism.

Firstly, U.S. Pat. No. 5,286,074, issued to Lin on Feb. 15, 1994, discloses a handle lock including a lever handle, a lock mechanism and a fixing member. The lever handle provides with a front side surface and a rear side surface identically parallel thereto. The front side surface with same configuration as the rear side surface is provided. Defined between the front side surface and the rear side surface is a lever body. The lever handle further includes an assembling through-hole connecting between the front side surface and the rear side surface. The lock mechanism provides with an inner spindle at its inner side and an outer spindled at its outer side. Each distal end of the inner and outer spindles includes an assembling section and a screw hole thereof.

In assembling operation, either of the front side surface or the rear side surface of the lever handle faces one of the inner or outer spindles that permit installing the assembling through-hole of the lever handle on the assembling section of the spindle. Finally, the fixing member securely connects the lever handle to the lock mechanism. In assembling step, the front side surface or the rear side surface of the lever handle can be selectively reversed to act as an inner or outer lever handle for applying to an inner or outer side of a door. Advantageously, the lever handle is suitable for both of the inner and outer spindles of the lock mechanism. Inevitably, due to the limitation of the fixing member, the spindle of the lock mechanism does not permit accommodating a lock core therein. Consequently, users cannot use a key member to lock or unlock the lock mechanism that may narrow the useful scope of the handle lock.

Secondly, U.S. Pat. No. 6,584,816, issued to Lee on Jul. 1, 2003, discloses a direction changeable lock structure including a lever handle, a lock mechanism, an inner ornamental cover and an outer ornamental cover. The lever handle provides with a front side surface and a rear side surface identically parallel thereto. The front side surface with same configuration as the rear side surface is provided. Connected between front side surface and a rear side surface is an assembling through-hole. The assembling through-hole consists of a central hole and an eccentric hole. The eccentric hole is in communication with the central hole. Also, the lock mechanism provides with an inner spindle at its inner side and an outer spindled at its outer side. A distal end of the outer spindle provides with a keyhole while a distal end of the inner spindle providing with a turn knob which is corresponding to the keyhole. One of the inner and outer ornamental covers permits insertion of the spindle of the lock mechanism. Each of the inner and outer ornamental covers includes an assembling section adapted to combine with the assembling through-hole of the lever handle.

In assembling operation, either of the front side surface or the rear side surface of the lever handle faces the inner or outer ornamental cover that permit installing the assembling through-hole of the lever handle on the assembling section of the ornamental cover. After assembling, the keyhole of the outer ornamental cover and the turn knob of the inner ornamental cover are exposed in an annular edge of the assembling through-holes of the lever handles for locking or unlocking operation. In assembling step, the front side surface or the rear side surface of the lever handle can be selectively reversed to act as an inner or outer lever handle for applying to an inner or outer side of a door. It is a disadvantage for the appearance that the spindle of the lock mechanism may be protruded or recessed on the side surface of the lever handle via the assembling through-hole. Therefore, there is a need for aligning the distal end of the spindle of the lock mechanism with the side surface of the lever handle.

The present invention intends to provide an alignment structure for combining a lever handle with a handle lock mechanism that a positioning protrusion of a spindle barrel of the handle lock mechanism engages with a retaining wall of the lever handle. Thereby, an assembling through-hole of the lever handle can precisely receive the spindle barrel, and a distal end of the spindle barrel of the handle lock mechanism is horizontally aligned with a side surface of the lever handle. Consequently, it may increase accuracy in aligning the lever handle with the handle lock mechanism, and therefore maintain product quality and reliability.

### SUMMARY OF THE INVENTION

The primary objective of this invention is to provide an alignment structure for combining a lever handle with a handle lock mechanism that employs a positioning protrusion of a spindle barrel of the handle lock mechanism engaging with a retaining wall of the lever handle. Consequently, it may increase accuracy in aligning the lever handle with the handle lock mechanism, and therefore maintain product quality and reliability.

The secondary objective of this invention is to provide the alignment structure for combining the lever handle with the handle lock mechanism, and the combination of the lever handle with the handle lock mechanism can be selectively changed by reverse for installing on either of a right or left side of a door plank.

The alignment structure in accordance with the present invention includes a handle lock mechanism, a lever handle and a spindle barrel. An end of the handle lock mechanism bears a spindle rod member to combine with the spindle barrel. The lever handle provides with an assembling through-hole and a retaining wall thereof. Received in the spindle barrel is the spindle rod member of the handle lock mechanism and the spindle barrel further provides with a positioning protrusion. In assembling operation, a recessed groove of the assembling through-hole engages with the positioning protrusion of the spindle barrel and the retaining wall of the lever handle abuts against the positioning protrusion of the spindle barrel. An end of the spindle barrel is exposed in an annular edge of the assembling through-hole and horizontally aligned with a side surface of the lever handle.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings wherein:

FIG. 1 is an exploded perspective view of an alignment structure for combining a lever handle with a handle lock mechanism in accordance with a first embodiment of the present invention;

FIG. 2 is an assembled cross-sectional view of the alignment structure for combining the lever handle with the handle lock mechanism in accordance with the first embodiment of the present invention;

FIG. 3 is an exploded perspective view of an alignment structure for combining a lever handle with a handle lock mechanism in accordance with a second embodiment of the present invention; and

FIG. 4 is an assembled cross-sectional view of the alignment structure for combining the lever handle combining with the handle lock mechanism in accordance with the second embodiment of the present invention.

### DETAILED DESCRIPTION OF THE INVENTION

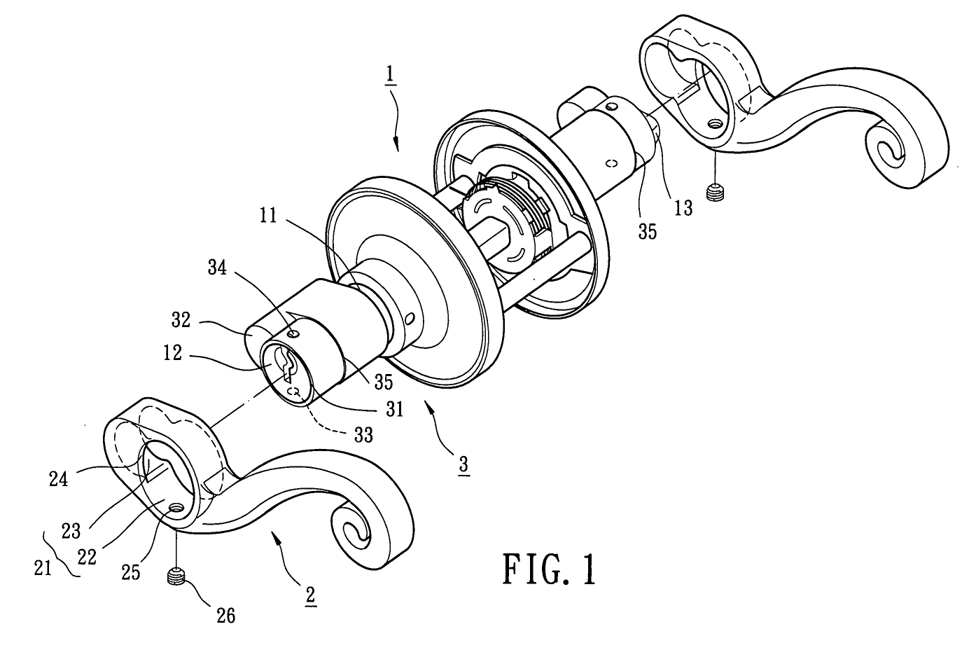

Referring initially to FIG. 1, it depicts an alignment structure for combining a lever handle with a handle lock mechanism in accordance with the first embodiment of the present invention. In the illustrated first preferred embodiment, the lever handle structure generally includes a handle lock mechanism 1, a lever handle 2 and a spindle barrel 3.

Referring to FIG. 1, the construction of the handle lock mechanism 1 shall now be described in detail. An end of the handle lock mechanism 1 bears a spindle rod member 11 to combine with the spindle barrel 3. The spindle rod member 11 of the handle lock mechanism 1 contains either of a lock core 12 (having a keyhole) or a turn button 13 that the spindle rod member 11 is regarded as an outer spindle rod member or an inner spindle rod member. The lock core 12 of the handle lock mechanism 1 is longitudinally aligned with the turn button 13.

Still referring to FIG. 1, the construction of the lever handle 2 shall now be described in detail. The lever handle 2 provides with an assembling through-hole 21, a retaining wall 24 and a screw hole 25. The assembling through-hole 21 includes an axial though-hole 22 and a recessed groove 23 formed on an inner circumference of the axial though-hole 22. The retaining wall 24 is located at a side surface of the lever handle 2 to enclose an end of the recessed groove 23. The screw hole 25 is provided on an annular wall of the lever handle 2 and adapted to receive a screw nut 26 which is used to mount the lever handle 2 to the spindle barrel 3.

Still referring to FIG. 1, the construction of the spindle barrel 3 shall now be described in detail. The spindle barrel 3 has a 8-shaped cross section, and includes an axial hole 31, at least one positioning protrusion 32 and a pair of screw hole 33, 34. The spindle barrel 3 is securely sleeved on the spindle rod member 11 of the handle lock mechanism 1. Alternatively, the spindle barrel 3 is integrated with the spindle rod member 11 of the handle lock mechanism 1 for the sake of manufacture ease. The positioning protrusion 32 is projected from an outer circumference of the spindle barrel 3 and corresponding to the recessed groove 23 of the lever handle 2. The screw hole 25 of the lever handle 2 is aligned with one of the screw holes 33, 34 of the spindle barrel 3 by reverse operation. Furthermore, the spindle barrel 3 includes a stepped portion 35 adapted to abut against an edge of the assembling through-hole 21 of the lever handle 2.

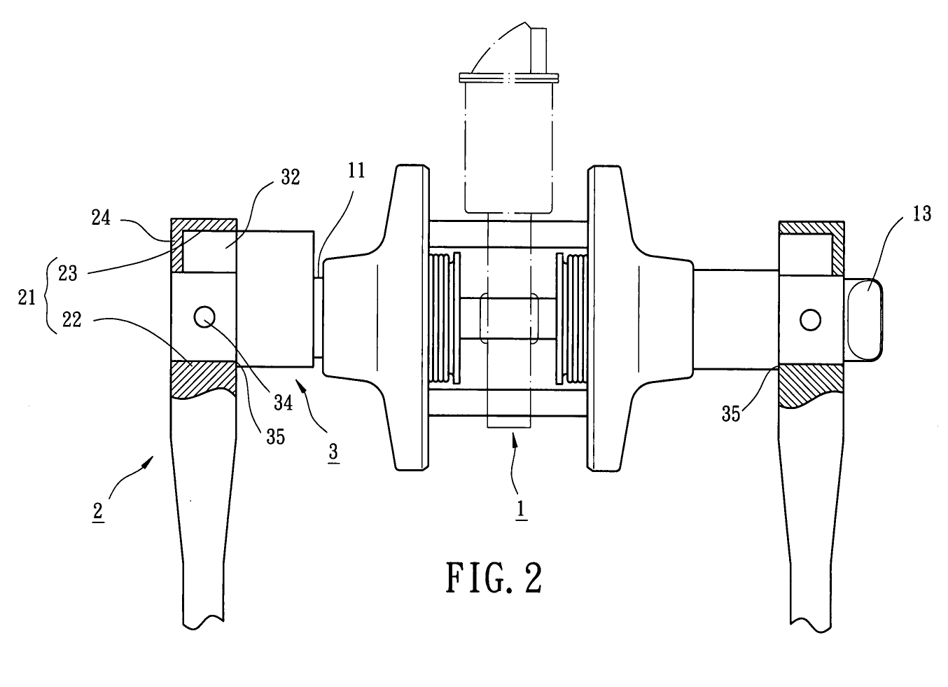

Turning now to FIG. 2, it depicts the lever handle structure combining with the handle lock mechanism in accordance with the first embodiment of the present invention. The spindle rod member 11 of the handle lock mechanism 1 accommodates the lock core 12 or the turn button which extends through an end opening of the handle lock mechanism 1. In assembling operation, after the spindle barrel 3 is combined with the spindle rod member 11, the lock core 12 or the turn button 13 is exposed in an annular edge of the axial hole 31 of the spindle barrel 3. Subsequently, the spindle barrel 3 extends through the assembling through-hole 21 of the lever handle 2 so that the positioning protrusion 32 of the spindle barrel 3 engages with the recessed groove 23 of the lever handle 2. The retaining wall 24 of the lever handle 2 abuts against the positioning protrusion 32 of the spindle barrel 3. Thus, the spindle barrel 3 cannot further extends through the assembling through-hole 21 of the lever handle 2 due to engagement of the positioning protrusion 32 of the spindle barrel 3 with the retaining wall 24 of the lever handle 2. Also, the stepped portion 35 of the spindle barrel 3 further engages with the edge of the assembling through-hole 21 of the lever handle 2. Consequently, it can avoid the end of the spindle barrel 3 being protruded from or recessed in the assembling through-hole 21 of the lever handle 2. The lever handle 2 can be precisely installed on the spindle barrel 3 that insures the end of the spindle barrel 3 horizontally aligned with the side surface of the lever handle 2. Thereby, it may improve the appearance of the lever handle and increase reliability of assembling the handle lock mechanism.

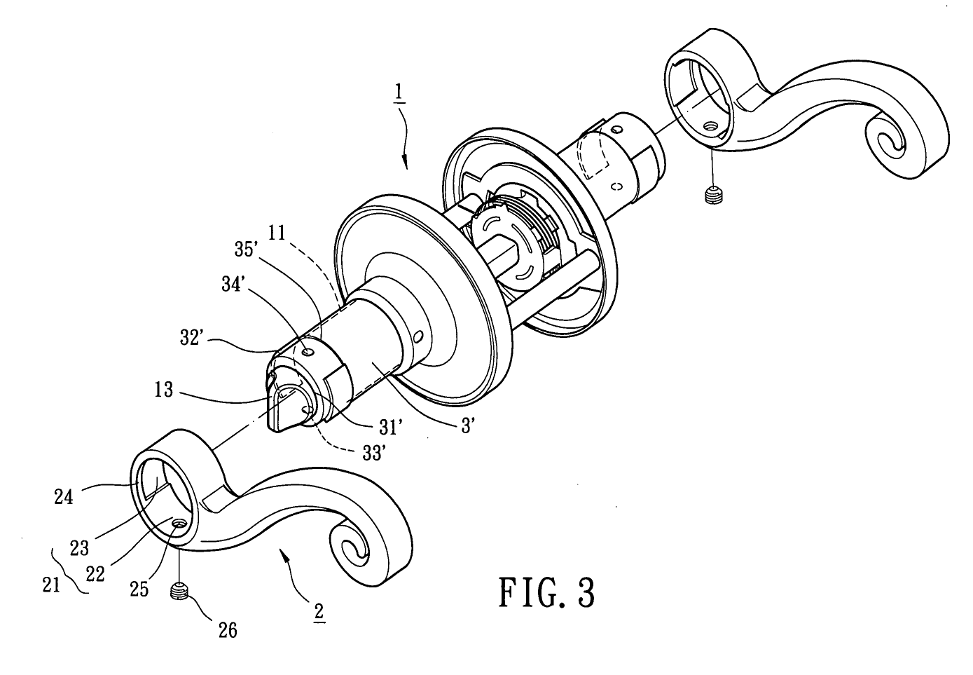

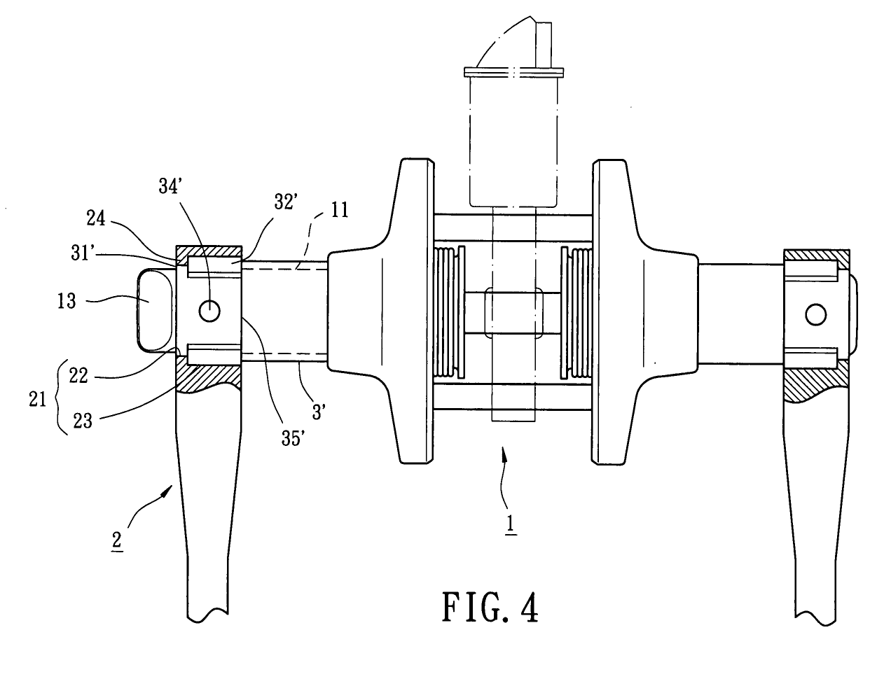

Turning now to FIGS. 3 and 4, reference numerals of the second embodiment of the present invention have applied the identical numerals of the first embodiment, as shown in FIG. 1. The construction of the alignment structure in accordance with the second embodiment of the present invention has similar configuration and same function as that of the first embodiment and detailed descriptions may be omitted.

Referring again to FIGS. 3 and 4, the alignment structure includes a handle lock mechanism 1, a lever handle 2 and a spindle barrel 3′. An end of the handle lock mechanism 1 bears a spindle rod member 11 to combine with the spindle barrel 3′. The spindle rod member 11 of the handle lock mechanism 1 is regarded as an outer spindle rod member or an inner spindle rod member. The lever handle 2 provides with an assembling through-hole 21, a retaining wall 24 and a screw hole 25. The assembling through-hole 21 includes an axial though-hole 22 and a recessed groove 23 formed on an inner circumference of the axial though-hole 22. The retaining wall 24 is located at a side surface of the lever handle 2 to enclose an end of the recessed groove 23. The screw hole 25 is provided on an annular wall of the lever handle 2 and adapted to receive a screw nut 26.

Referring again to FIGS. 3 and 4, in comparison with the first embodiment, the spindle barrel 3′ is a cylindrical member, and includes an axial hole 31′, at least one positioning protrusion 32′, a pair of screw hole 33′, 34′ and a stepped portion 35′. The spindle barrel 3′ is securely sleeved on the spindle rod member 11 of the handle lock mechanism 1. Alternatively, the spindle barrel 3′ is integrated with the spindle rod member 11 of the handle lock mechanism 1. The positioning protrusion 32′ is projected from an outer circumference of the spindle barrel 3′ and corresponding to the recessed groove 23 of the lever handle 2. The screw hole 25 of the lever handle 2 is aligned with one of the screw holes 33′, 34′ of the spindle barrel 3′ by reverse operation. Furthermore, the spindle barrel 3′ includes a stepped portion 35′ adapted to abut against an edge of the assembling through-hole 21 of the lever handle 2.

Still referring to FIGS. 3 and 4, in assembling operation, after the spindle barrel 3′ is combined with the spindle rod member 11, the turn button 13 is exposed in an annular edge of the axial hole 31′ of the spindle barrel 3′. Subsequently, the spindle barrel 3′ extends through the assembling through-hole 21 of the lever handle 2 so that the positioning protrusion 32′ of the spindle barrel 3′ engages with the recessed groove 23 of the lever handle 2. The spindle barrel 3′ cannot further extends through the assembling through-hole 21 of the lever handle 2 due to engagement of the positioning protrusion 32′ of the spindle barrel 3′ with the retaining wall 24 of the lever handle 2. Also, the stepped portion 35′ of the spindle barrel 3′ further engages with the edge of the assembling through-hole 21 of the lever handle 2. Consequently, it can avoid the end of the spindle barrel 3′ being protruded from or recessed in the assembling through-hole 21 of the lever handle 2. The lever handle 2 can be precisely installed on the spindle barrel 3′ that insures the end of the spindle barrel 3′ horizontally aligned with the side surface of the lever handle 2. Thereby, it may improve the appearance of the lever handle and increase reliability of assembling the handle lock mechanism.

Referring back to FIGS. 1 and 3, the handle lock mechanism 1 can be selectively installed on a left or right side of a door plank (not shown). The lever handle 2 can be changed by reverse that permits the assembling through-hole 21 to assemble to the spindle barrel 3, 3′ on an inner or outer side of the door plank. Thereby, the retaining wall 24 made the entire structure of the lever handle 2 simple for ease of manufacture and reduction of manufacture cost.

Although the conventional lever handle and the handle lock mechanism are suitable for two sides of the door plank, the conventional lever handle cannot be precisely assembled with the handle lock mechanism. It will be apparent from the aforementioned discussions that the retaining wall 24 and the positioning protrusion 32 of the present invention can provide the lever handle 2 precisely aligned with the spindle barrel 3. Furthermore, the engagement of the assembling through-hole 21 with the stepped portion 35 of the present invention provides the lever handle 2 precisely aligned with the spindle barrel 3.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. An alignment structure for combining a lever handle with a handle lock mechanism comprising:
a spindle rod member provided on a side of the handle lock mechanism, the spindle rod member including an end;
a spindle barrel sleeved on the end of the spindle rod member for combining with the handle lock mechanism, the spindle barrel including an end;
at least one positioning protrusion provided on an outer circumference of the spindle barrel;
an assembling through-hole provided on the lever handle, the assembling through-hole including an axial through-hole and a recessed groove formed on an inner circumference of the axial through-hole; and
at least one retaining wall located at a side surface of the lever handle to enclose an end of the recessed groove of the assembling through-hole;
wherein when the spindle barrel is inserted into the assembling through-hole of the lever handle, the positioning protrusion of the spindle barrel is engaged with the recessed groove of the assembling though-hole;
wherein when the retaining wall abuts against the positioning protrusion of the spindle barrel, the end of the spindle barrel is exposed in an annular edge of the assembling through-hole and horizontally aligned with a side surface of the lever handle.

2. The alignment structure for combining the lever handle with the handle lock mechanism as defined in claim 1, wherein the spindle barrel further includes a stepped portion abutted against an edge of the assembling through-hole of the lever handle when assembled.

3. The alignment structure for combining the lever handle with the handle lock mechanism as defined in claim 1, wherein the lever handle provides with at least one screw hole formed on an annular wall and said screw hole is adapted to receive a screw nut which is used to mount the lever handle to the spindle barrel.

4. The alignment structure for combining the lever handle with the handle lock mechanism as defined in claim 3, wherein the spindle barrel further includes at least one screw hole corresponding to the screw nut of the lever handle for securely combining the lever handle with the spindle barrel.

5. The alignment structure for combining the lever handle with the handle lock mechanism as defined in claim 1, wherein the spindle barrel is integrated with the spindle rod member.

6. The alignment structure for combining the lever handle with the handle lock mechanism as defined in claim 5, wherein the spindle barrel further includes at least one screw hole corresponding to the screw nut of the lever handle for securely combining the lever handle with the spindle barrel.

7. The alignment structure for combining the lever handle with the handle lock mechanism as defined in claim 1, wherein the spindle barrel receives a lock core therein.

8. The alignment structure for combining the lever handle with the handle lock mechanism as defined in claim 1, wherein the spindle barrel receive a turn button.
